(19) United States
(12) Patent Application Publication
(10) Pub. No.: US 2002/0185853 A1
(43) Pub. Date: Dec. 12, 2002

(54) Adjustable mud flap holder

(76) Inventor: Alan J. Gaudet, Sparr, FL (US)

Correspondence Address: Edward M. Livingston, Esq., 628 Ellen Dr., P.O. Box 1599, Winter Park, FL, 32790, US

(21) Appl. No.: 09/855,405

(22) Filed: May 15, 2001

(51) Int. Cl. B62B 9/16

(52) U.S. Cl. 280/847

(57) ABSTRACT

An adjustable mud-flap holder has a flap rod (1) with a first attachment arm (5) extended orthogonally for attachment to a first vehicle rod and a second attachment arm (8) extended orthogonally for attachment to a second vehicle rod. The first attachment arm and the second attachment arm have insert projections (10) that are disposed oppositely for insertion into vehicle-rod apertures (11) for fastening the mud-flap holder to a vehicle (7, 26) aft of rear wheels (2, 3) of the vehicle predeterminedly. The flap rod has a first end (12) with a first mud-flap fastener and a second end (13) with a second mud-flap fastener to fasten mud flaps (4) to the flap rod predeterminedly.

### BACKGROUND OF THE INVENTION

This invention relates to mud-flap holders, and more particularly to mud flap holders having adjustability of distance behind rear wheels of highway trailers that have wheel-positioning slide rails with positioning holes.

Known mud-flap holders for highway trailers do not have adjustability of distance behind wheels and are not attached detachably in a manner taught by this invention.

Mud flaps that are too close to rear wheels near ends of trailers and trucks often get pulled off from being caught between tires and curbs when turning or backing up. Mud flaps that are too far behind the rear wheels do not shield widely enough against rocks and other road debris. Mud flaps on parked trailers or trucks get vandalized frequently.

Thus, a need exists for a mud flap holder that will decrease the likelihood of damage and theft associated with current mud flap holders.

Examples of most-closely related known but different devices are described in the following patent documents:

| U.S. | | Issue |
|---|---|---|
| Pat. No. | Inventor | Date |
| 4,221,432 | VanRemortel, et al. | 09/09/1980 |
| 4,856,816 | Francis | 08/15/1989 |
| 4,326,727 | Rock | 04/27/1982 |
| 3,877,722 | Conner | 04/15/1975 |
| 6,179,311 B1 | Larkin, et al. | 01/30/2001 |
| 6,076,842 | Knoer | 06/20/2000 |
| 4,541,646 | Knowley | 09/17/1985 |
| 5,833,254 | Bucho | 11/10/1998 |

### SUMMARY OF THE INVENTION

In light of these and other problems, objects of patentable novelty and utility taught by this invention are to provide an adjustable mud-flap holder which:

has adjustability of distance behind rear wheels of truck trailers;

utilizes adjustment holes in standard slide rails for adjustable fastening to trailers;

is conveniently attachable to backs of trailers and trucks detachably for ease and convenience of adjustment of distance of mud flaps behind the rear wheels;

allows convenient adjustment of distances of mud flaps from rear ends of trailers commensurate with changing of distances of trailer wheels from rear ends of slide rails proximate rear ends of trailers as appropriate for sharpness of turning radii and for load-weight situation on trailers selectively; and

is conveniently detachable from backs of trailers and trucks for storage in the trailer or truck to protect against vandalism when the trailer or truck is parked or not being used on public roads.

This invention accomplishes these and other objectives with an adjustable mud-flap holder having a flap rod with a first attachment arm extended orthogonally for attachment to a first vehicle rod and a second attachment arm extended orthogonally for attachment to a second vehicle rod. The first attachment arm and the second attachment arm have vehicle-rod inserts that are disposed oppositely for insertion into vehicle-rod apertures to fasten the mud-flap holder to a vehicle aft of rear wheels of the vehicle predeterminedly. The flap rod has a first end with a first mud-flap fastener and a second end with a second mud-flap fastener to fasten mud flaps to the flap rod predeterminedly.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a rear view of an adjustable mud-flap holder having a flap rod with adjustable length and with insert projections extended in opposite directions outwardly into slide-rail apertures in slide rails on a truck trailer;

FIG. 2 is a side view of the FIG. 1 adjustable mud-flap holder on a partially cutaway side view of the truck trailer;

FIG. 3 is a rear view of an adjustable mud-flap holder having a flap rod with adjustable length and with the insert projections extended in opposite directions inwardly into the slide-rail apertures and having rail-rider steps that are articulated to ride on slide-rail shelves of the slide rails on the truck trailer;

FIG. 4 is a side view of the FIG. 3 adjustable mud-flap holder on a partially cutaway side view of the truck trailer;

FIG. 5 is a rear view of an adjustable mud-flap holder having a flap rod with fixed length, with the insert projections extended adjustably in opposite directions outwardly and with rotational rail-ride members that bracket the slide rails and ride on the shelves of the slide rails;

FIG. 6 is a side view of the FIG. 5 adjustable mud-flap holder on a partially cutaway side view of the truck trailer;

FIG. 7 is a rear view of an adjustable mud-flap holder having a flap rod with adjustable length and with the insert projections extended in opposite directions inwardly into chassis-rod apertures on a trailer truck;

FIG. 8 is a side view of the FIG. 7 adjustable mud-flap holder on a partially cutaway side view of the trailer truck;

FIG. 9 is an exploded and partially cutaway rear view of the flap rod with flap attachments having anti-theft fasteners and lock caps for resistance of theft of mud flaps from the flap rod;

FIG. 10 is an exploded view of a centrally outward left-end portion of the flap rod of the FIG. 9 illustration;

FIG. 11 is a cross-section view of the FIG. 10 illustration through section line 11-11;

FIG. 12 is a side elevation view of an interchangeable wrench for mud flaps and for lock caps on the flap rod;

FIG. 13 is a socket-end view of the FIG. 12 illustration; and

FIG. 14 is a partially cutaway side view of a lock cap having a sleeve for attachment to the flap rod.

### DESCRIPTION OF PREFERRED EMBODIMENT

Listed numerically below with reference to the drawings are terms used to describe features of this invention. These terms and numbers assigned to them designate the same features throughout this description.

```
  1. Flap rod
  2. First rear wheel
  3. Second rear wheel
  4. Mud flaps
  5. First attachment arm
  6. First slide rail
  7. Truck trailer
  8. Second attachment arm
  9. Second slide rail
10. Insert projection
11. Slide-rail apertures
12. First end of flap rod
13. Second end of flap rod
14. Rail-rider steps
15. Slide-rail shelves
16. Rod-length adjuster
17. First rail-rider arm
18. First side
19. First rail-rider member
20. Second rail-rider arm
21. Second side
22. Second rail-ride member
23. Attachment-arm adjuster
24. First chassis rod
25. Second chassis rod
26. Truck
27. Chassis-rod apertures
28. Insert-attachment aperture
29. Insert fastener
30. Anti-theft fasteners
31. First lock cap
32. Second lock cap
33. Set screws
34. Irregular wrench flats
35. Irregular fastener flats
36. Interchangeable wrench
37. Lock rod
38. Lock sleeves
39. Wrench walls
40. Wrench ring
41. Round nuts
42. Inside ridge
43. Sleeve lock cap
```

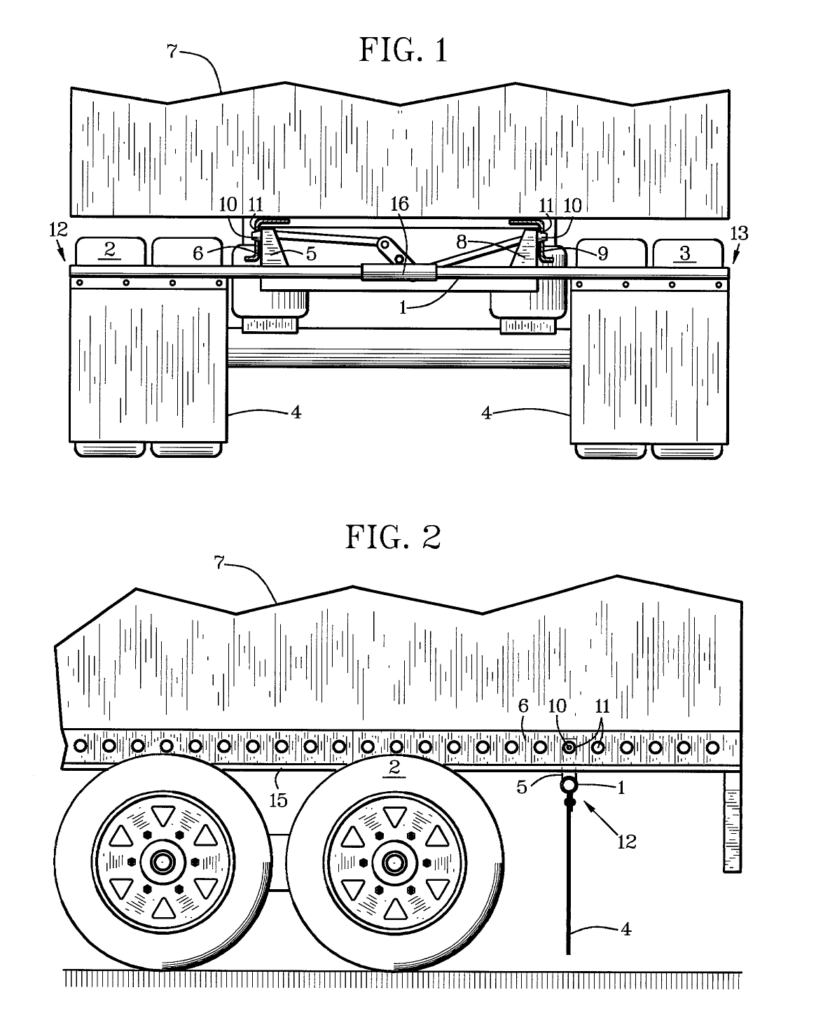

Referring first to FIGS. 1-2, an adjustable mud-flap holder has a flap rod 1 that extends intermediate proximate outside edges of a first rear wheel 2 and a second rear wheel 3 of a vehicle that is required by law to have mud flaps 4. A first attachment arm 5 is extended orthogonally from the flap rod 1 for attachment to a first vehicle rod which can include a first slide rail 6 of a truck trailer 7. A second attachment arm 8 is extended orthogonally from the flap rod 1 for attachment to a second vehicle rod which can include a second slide rail 9 of the truck trailer 7.

Vehicle-rod attachments, which can include insert projections 10 on the first attachment arm 5 and on the second attachment arm 8, are attached detachably to the first vehicle rod and to the second vehicle rod preferably by insertion of the insert projections 10 into selectable slide-rail apertures 11 in the first slide rail 6 and in the second slide rail 9 on a bottom of the truck trailer 7. The insert projections 10 include tapered rubberlike outside peripheries.

The insert projections 10 on the first attachment arm 5 and on the second attachment arm 8 are paired insert projections 10 which are extended in opposite directions from the first attachment arm 5 and from the second attachment arm 8 respectively for entering the slide-rail apertures 11 from opposite directions. The opposite directions can include linearly outward with a first insert projection 10 extended in a direction towards a first end 12 of the flap rod 1 and with a second insert projection 10 extended in a direction towards a second end 13 of the flap rod 1. In this embodiment, the paired insert projections 10 are inserted into the slide-rail 3 apertures 11 from inside-facing walls of the first slide rail 6 and of the second slide rail 9.

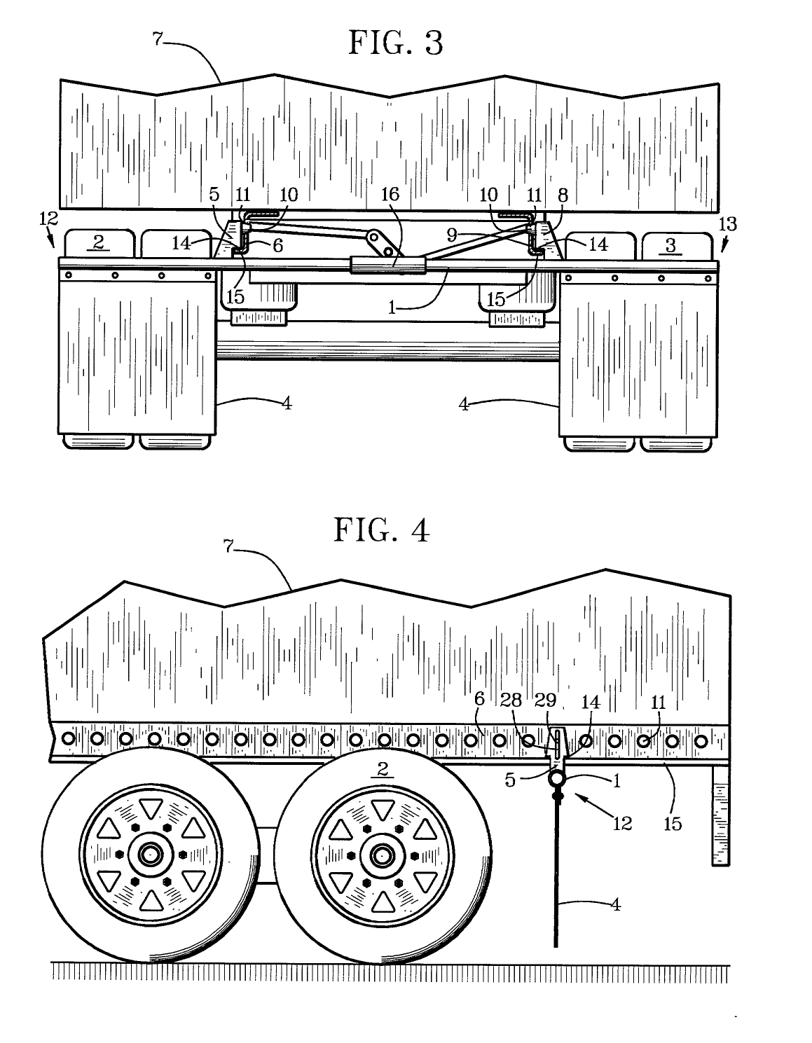

Referring to FIGS. 3-4, the opposite directions of extension of the insert projections 10 can include linearly inward with a first insert projection 10 extended in a direction towards the second end 13 of the flap rod 1 and with the second insert projection 10 extended in a direction towards the first end 12 of the flap rod 1. In this embodiment, the paired insert projections 10 are inserted into the slide-rail apertures 11 from outwardly-facing walls of the first slide rail 6 and of the second slide rail 9.

The first attachment arm 5 and the second attachment arm 8 can include rail-rider steps 14 that are articulated to ride on slide-rail shelves 15 of slide rails 6 and 9 that are in common use for sliding rear wheels of trailers forward to accommodate primarily sharp turning in cities and rearward to accommodate primarily trailing stability for highway use. Forward and aft sliding is employed also to accommodate varying load concentration on trailers. The slide-rail shelves 15 are primarily for structural-beam integrity, but can be employed also for slidable support of the flap rod 1 and the mud flaps 4 that can hang from it.

Referring to FIGS. 1, 3 and 7, the flap rod 1 can include a rod-length adjuster 16 intermediate the first attachment arm 5 and the second attachment arm 8 for extractible insertion of the insert projections 10 in the slide-rail apertures 11. The rod-length adjuster 16 can employ known counter-threading and/or appropriately tensioned springs and other known length adjustment techniques.

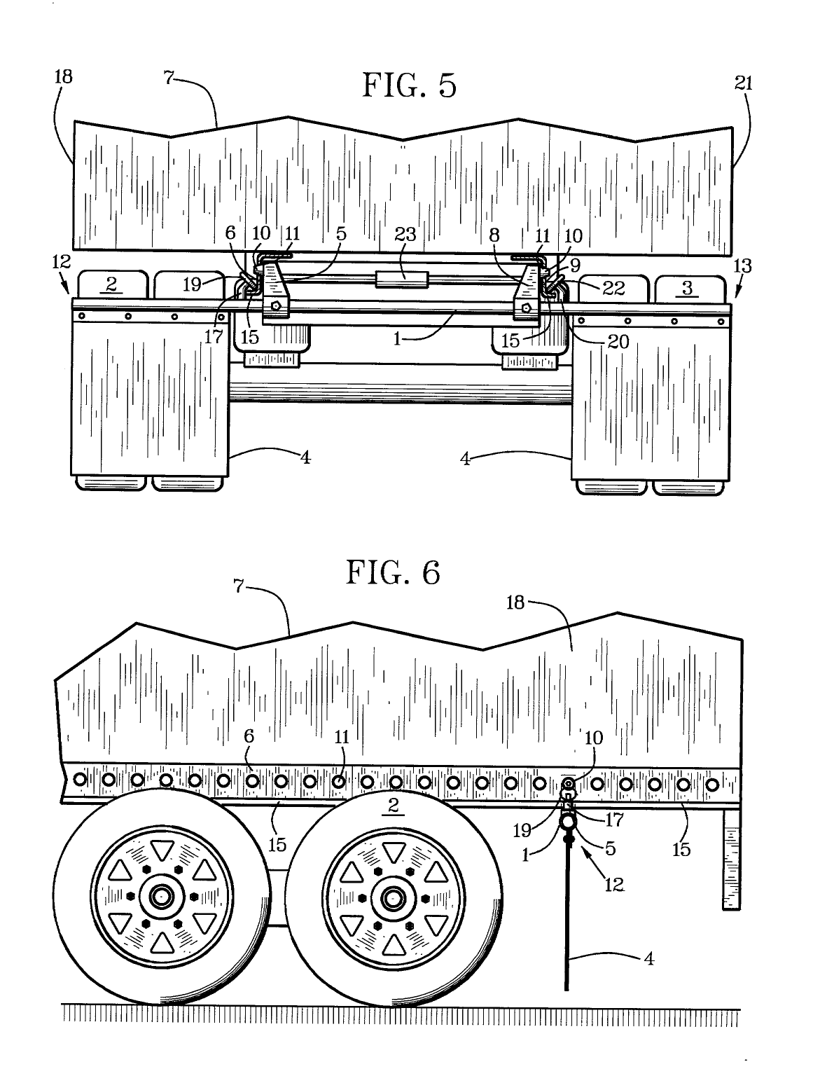

Referring to FIGS. 5-6, the flap rod 1 can include a first rail-rider arm 17 that is extended vertically upward at a distance from the first end 12 of the flap rod 1 which is proximate a distance of a conventional first slide rail 6 from a first side 18 of the truck trailer 7. A first rail-ride member 19, which preferably is rotational, is extended predeterminedly from the first rail-rider arm 17 to ride on a first one of the slide-rail shelves 15. A second rail-rider arm 20 is extended vertically upward at a distance from the second end 13 of the flap rod 1 which is proximate a distance of a conventional second slide rail 9 from a second side 21 of the truck trailer 7. A second rail-ride member 22, which preferably is rotational, is extended predeterminedly from the second rail-rider arm 20 to ride on a second one of the slide-rail shelves 15.

The first rail-ride member 19 and the second rail-ride member 22 are a fixed distance apart for bracketing the first slide rail 6 and the second slide rail 9. The first attachment arm 5 and the second attachment arm 8 are slidable on the flap rod 1 to detachably engage the first vehicle-rod attachment with the first slide rail 6 and to detachably engage the second vehicle-rod attachment with the second slide rail 9 predeterminedly. An attachment-arm adjuster 23 can be provided for selective control of distance between the first attachment arm 5 and the second attachment arm 8

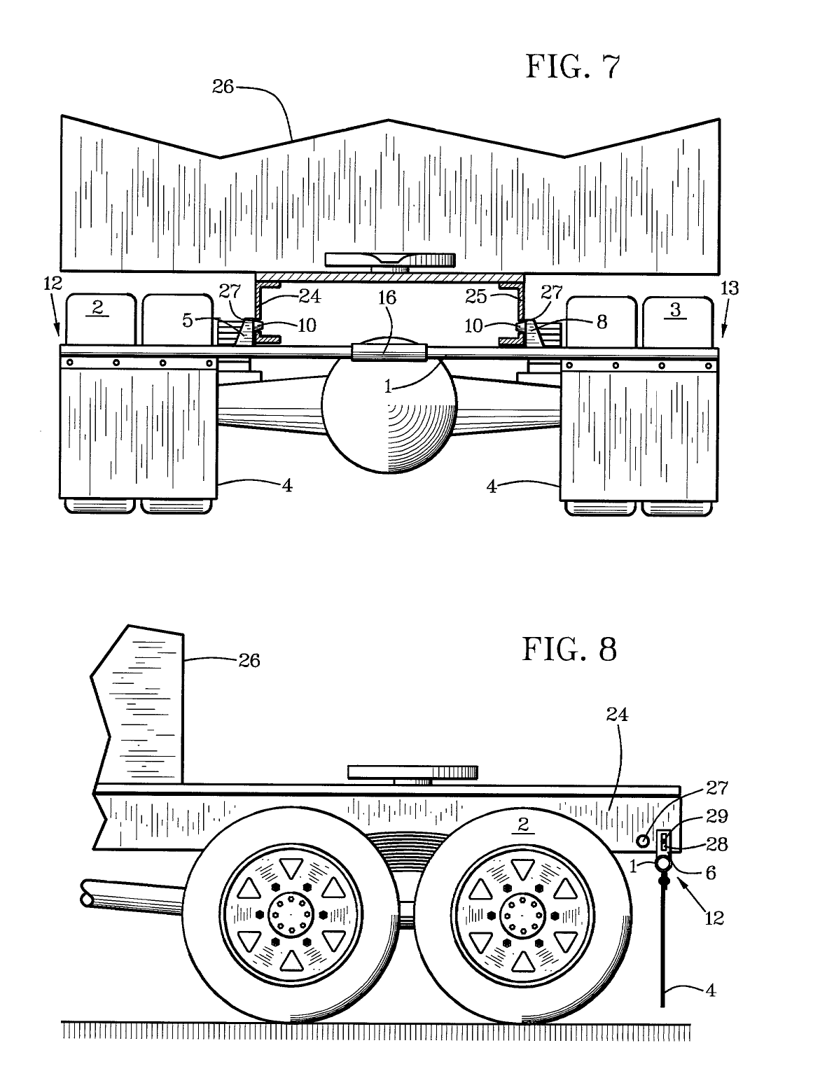

Referring to FIGS. 7-8, the first vehicle rod can include a first chassis rod 24 and the second vehicle rod can include a second chassis rod 25 of a truck 26 having chassis-rod apertures 27 into which the insertion projections 10, preferably having tapered rubberlike outside peripheries, on the first attachment arm 5 and on the second attachment arm 8 are inserted extractively as paired insert projections 10 from opposite directions. The opposite directions from which the paired insertion projections 10 are extended from the first attachment arm 5 and from the second attachment arm 8 respectively are linearly inward with a first one of the insert projections 10 extended in a direction towards the second end 13 of the flap rod 1 and a second one of the insert projections 10 extended in a direction towards the first end 12 of the flap rod 1.

The paired insert projections 10 are inserted into the chassis-rod apertures 27 from outwardly-facing walls of the first chassis rod 24 and the second chassis rod 25 respectively. The flap rod 1 includes the rod-length adjuster 16 intermediate the first attachment arm 5 and the second attachment arm 8.

Referring to FIGS. 4 and 8, the first attachment arm 5 and the second attachment arm 8 can include height adjusters for adjustment of distances of separation of the vehicle-rod attachment on the first attachment arm 5 and the vehicle-rod attachment on the second attachment arm 8 from the flap rod 1. The height adjusters can include an insert-attachment aperture 28 that is elongate vertically for receiving an insert fastener 29 for a vehicle-rod attachment for the first attachment arm 5 and for the second attachment arm 8 respectively.

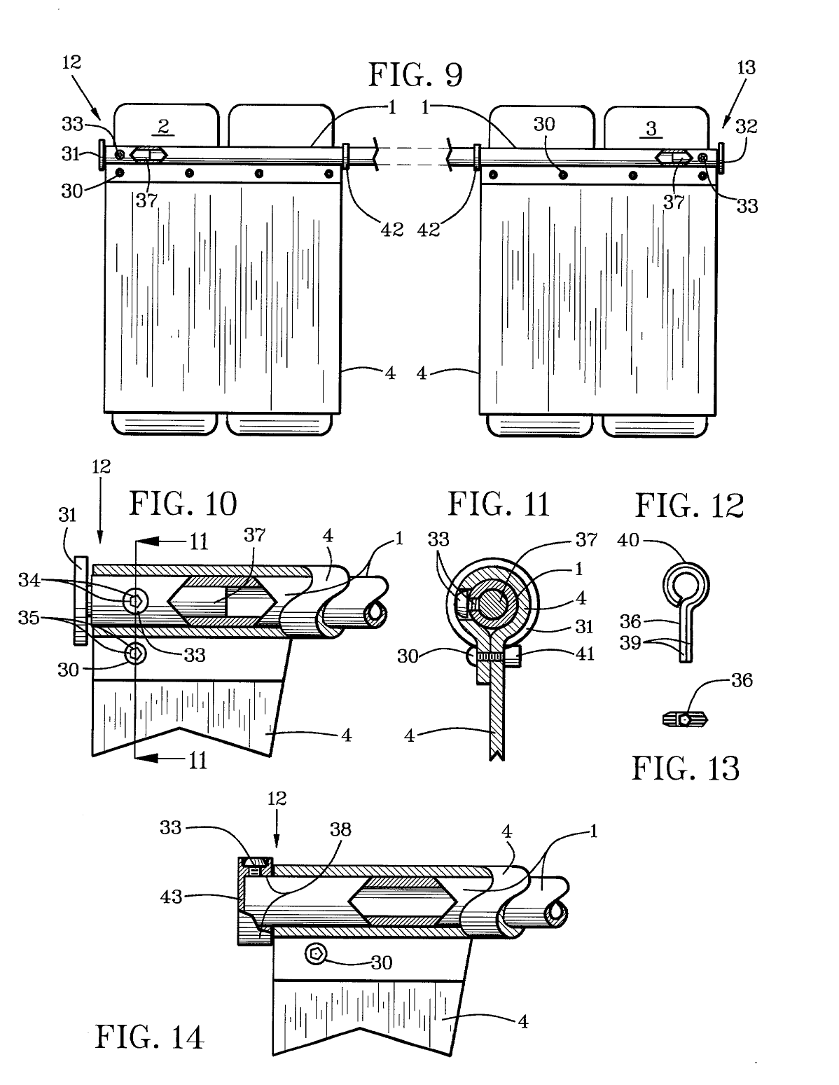

Referring to FIGS. 9-14, the adjustable mud-flap holder can have flap attachments that include a first flap attachment proximate the first end 12 and a second flap attachment proximate the second end 13 of the flap rod 1. The flap attachments can include anti-theft fasteners 30 with which the mud flaps 4 are fastened to the flap rod 1. The flap attachments can include a first lock cap 31 that is locked onto the first end 12 of the flap rod 1 and a second lock cap 32 that is locked onto the second end 13 of the flap rod 1 to arrest outward travel of the mud flaps 4 which are fastened to the flap rod 1.

The first lock cap 31 and the second lock cap 32 are locked onto the flap rod 1 with set screws 33 having predeterminedly irregular wrench flats 34 shown in FIG. 10 for mating with a set-screw wrench having wrench walls which mate with the irregular wrench flats 34 of the set screws 33.

The anti-theft fasteners 30 can include wrench-contact surfaces with predeterminedly irregular fastener flats 35 shown in FIG. 10 and a flap wrench having wrench walls which mate with the predeterminedly irregular fastener flats 35 of the wrench-contact surfaces. The wrench-contact surfaces can be on a socket bay and the and the flap wrench can include a rod socket wench having irregular wrench walls which mate with the irregular wrench flats 34. The irregular wrench flats 34 of the set screw 33 and the wrench walls of the anti-theft fasteners 30 can have mating dimensions. The set-screw wrench and the flap wrench can have dimensions which mate with dimensions of an interchangeable wrench 36 that can be used for the anti-theft fasteners 30 and for the set screws 33 interchangeably. Domed or flat socket heads of the set screws 33 can be countersunk to further resist theft.

For the first lock cap 31 and for the second lock cap 32 having a lock rod 37 that is inserted into the flap rod 1, the set screw 33 is threaded through a wall of the flap rod 1 to engage the lock rod 37. For sleeve lock caps 43 having lock sleeves 38 shown in FIG. 14, the set screws 33 are threaded through the lock sleeves 38 to engage the flap rod 1.

The interchangeable wrench 36 can be a rod wrench having an irregular plurality and/or irregular lengths of wrench walls 39. A plurality of five wrench walls 39 are illustrated on the interchangeable wrench 36 that can have a wrench ring 40 for attachment to a key chain or key ring and for finger leverage for turning the set screw 33 and the anti-theft fasteners 30.

The anti-theft fasteners 30 can be screwed into round nuts 41, dome nuts or other irregular fastener nuts to enhance anti-theft characteristics.

An inside ridge 42 or wall on the flap rod 1 can be provided as shown in FIG. 9 to arrest inward travel of the mud flaps 4.

The flap rod 1 is illustrated as being round but can be square or otherwise polygonal.

A new and useful adjustable mud-flap holder having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. An adjustable mud-flap holder comprising:
a flap rod having a first end articulated to extend to proximate an outside edge of a first rear wheel of a vehicle and a second end articulated to extend to proximate an outside edge of a second rear wheel of the vehicle;
a first attachment arm extended orthogonally from the flap rod for attachment to a first vehicle rod;
a second attachment arm extended orthogonally from the flap rod for attachment to a second vehicle rod;
a vehicle-rod attachment on the first attachment arm;
a vehicle-rod attachment on the second attachment arm; and
the vehicle-rod attachment on the first attachment arm and the vehicle-rod attachment on the second attachment arm being oppositely disposed for fastening the flap rod to the vehicle aft of the first rear wheel and aft of the second rear wheel.

2. The adjustable mud-flap holder of claim 1 wherein:
the first vehicle rod includes a first slide rail proximate a bottom of a trailer; and
the second vehicle rod includes a second slide rail proximate a bottom of the trailer.

3. The adjustable mud-flap holder of claim 2 wherein:
the first slide rail and the second slide rail have slide-rail apertures;
the vehicle-rod attachment on the first attachment arm includes an insert projection that can be inserted into a slide-rail aperture in the first slide rail; and
the vehicle-rod attachment on the second attachment arm includes an insert projection that can be inserted into a slide-rail aperture in the second slide rail.

4. The adjustable mud-flap holder of claim 3 wherein:
the insert projection on the first attachment arm and the insert projection on the second attachment arm include tapered rubberlike outside peripheries that contact inside peripheries of the slide-rail apertures.

5. The adjustable mud-flap holder of claim 4 wherein:
the insert projection on the first attachment arm and the insert projection on the second attachment arm are paired insert projections which are extended in opposite directions from the first attachment arm and from the second attachment arm respectively for entering the slide-rail apertures from opposite directions.

6. The adjustable mud-flap holder of claim 5 wherein:
the opposite directions from which the paired insert projections are extended from the first attachment arm and from the second attachment arm respectively include linearly outward with a first insert projection extended in a direction towards a first end of the flap rod and a second insert projection extended in a direction towards a second end of the flap rod; and
the paired insert projections are inserted into the slide-rail apertures from inside-facing walls of the first slide rail and of the second slide rail.

7. The adjustable mud-flap holder of claim 5 wherein:
the opposite directions from which the paired insert projections are extended from the first attachment arm and from the second attachment arm respectively include linearly inward with the first insert projection extended in a direction towards the second end of the flap rod and the second insert projection extended in a direction towards the first end of the flap rod; and
the paired insert projections are inserted into the slide-rail apertures from outwardly-facing walls of the first slide rail and of the second slide rail.

8. The adjustable mud-flap holder of claim 7 wherein:
the first attachment arm and the second attachment arm include rail-rider steps that are articulated to ride on slide-rail shelves.

9. The adjustable mud-flap holder of claim 5 wherein:
the flap rod includes a rod-length adjuster intermediate the first attachment arm and the second attachment arm for extractible insertion of the insert projections in the slide-rail apertures.

10. The adjustable mud-flap holder of claim 1 and further comprising:
a first rail-rider arm extended vertically upward from the flap rod at a distance from the first end of the flap rod that is proximate a distance of the first slide rail from a first side of the truck trailer;
a first rail-ride member extended predeterminedly from the first rail-rider arm to ride on a first one of the rail shelves on a bottom of the first slide rail that is on the bottom of the truck trailer;
a second rail-rider arm extended vertically upward from the flap rod at a distance from the second end of the flap rod that is proximate a distance of the second slide rail from a second side of the truck trailer;
a second rail-ride member extended predeterminedly from the second rail-rider arm to ride on a second one of the rail shelves on a bottom of the second slide rail that is on the bottom of the truck trailer;
the first rail-ride member and the second rail-ride member being a fixed distance apart for bracketing the first slide rail and the second slide rail; and
the first attachment arm and the second attachment arm being slidable on the flap rod to detachably engage the first vehicle-rod attachment with the first slide rail and to detachably engage the second vehicle-rod attachment with the second slide rail predeterminedly.

11. The adjustable mud-flap holder of claim 10 wherein:
the first rail-ride member and the second rail-ride member are predeterminedly rotational for rotationally riding support of the flap rod on rail shelves of a pair of conventional slide rails for adjustment of the adjustable mud-flap holder.

12. The adjustable mud-flap holder of claim 1 wherein:
the first vehicle rod is a first chassis rod of a truck; and
the second vehicle rod is a second chassis rod of a truck.

13. The adjustable mud-flap holder of claim 12 wherein:
the first chassis rod and the second chassis rod have chassis-rod apertures;
the vehicle-rod attachment on the first attachment arm includes an insert projection that can be inserted into a chassis-rod aperture in the first chassis rod; and
the vehicle-rod attachment on the second attachment arm includes an insert projection that can be inserted into a chassis-rod aperture in the second chassis rod.

14. The adjustable mud-flap holder of claim 13 wherein:
the insert projection on the first attachment arm and the insert projection on the second attachment arm include tapered rubberlike outside peripheries that contact inside peripheries of the chassis-rod apertures.

15. The adjustable mud-flap holder of claim 14 wherein:
the insert projection on the first attachment arm and the insert projection on the second attachment arm are paired insert projections which are extended in opposite directions from the first attachment arm and from the second attachment arm respectively for entering the chassis-rod apertures from opposite directions.

16. The adjustable mud-flap holder of claim 15 wherein:
the opposite directions from which the paired insert projections are extended from the first attachment arm and from the second attachment arm respectively are linearly inward with a first one of the insert projections extended in a direction towards the second end of the flap rod and a second one of the insert projections extended in a direction towards the first end of the flap rod; and
the paired insert projections are inserted into the chassis-rod apertures from outwardly-facing walls of the first chassis rod and the second chassis rod respectively.

17. The adjustable mud-flap holder of claim 16 wherein:
the flap rod includes the rod-length adjuster intermediate the first attachment arm and the second attachment arm.

18. The adjustable mud-flap holder of claim 1 wherein:
the first attachment arm and the second attachment arm include height adjusters for adjustment of distances of separation of the vehicle-rod attachment on the first attachment arm and the vehicle-rod attachment on the second attachment arm from the flap rod.

19. The adjustable mud-flap holder of claim 18 wherein:
the height adjusters include an insert-attachment aperture that is elongate vertically in the first attachment arm for receiving an insert fastener for a vehicle-rod attachment and an insert-attachment aperture that is elongate vertically in the second attachment arm for receiving a fastener for a vehicle-rod attachment.

20. The adjustable mud-flap holder of claim 1 and further comprising:
flap attachments that include a first flap attachment proximate the first end and a second flap attachment proximate the second end of the flap rod.

21. The adjustable mud-flap holder of claim 20 wherein:
the flap attachments include anti-theft fasteners with which the mud flaps are fastened to the flap rod.

22. The adjustable mud-flap holder of claim 21 wherein:
the flap attachments include a first lock cap that is locked onto the first end of the flap rod and a second lock cap that is locked onto the second end of the flap rod to arrest outward travel of mud flaps which are fastened to the flap rod.

23. The adjustable mud-flap holder of claim 22 wherein:
the first lock cap and th e second lock cap are locked onto the flap rod with set screws having predeterminedly irregular wrench flats for mating with a set-screw wrench having wrench walls which mate with the irregular wrench flats of the set screws.

24. The adjustable mud-flap holder of claim 23 wherein:
the anti-theft fasteners include wrench-contact surfaces with predeterminedly irregular fastener flats and a flap wrench having wrench walls which mate with the predeterminedly irregular fastener flats of the wrench-contact surfaces.

25. The adjustable mud-flap holder of claim 24 wherein:
the wrench-contact surfaces are on a socket bay and the flap wrench includes a rod socket wrench having irregular wrench walls which mate with the irregular wrench flats.

26. The adjustable mud-flap holder of claim 25 wherein:
the irregular wrench flats of the set screws and the wrench walls of the anti-theft fasteners have mating dimensions; and
the set-screw wrench and the flap wrench have mating dimensions which are equal to mating dimensions of an interchangeable wrench.
